(19) United States
(12) Patent Application Publication
(10) Pub. No.: US 2014/0058966 A1
(43) Pub. Date: Feb. 27, 2014

(54) System and Method for Delivering Serialized Stories

(71) Applicants: John Saul, Kailua-Kona, HI (US); Mike Sack, Kailua-Kona, HI (US)

(72) Inventors: John Saul, Kailua-Kona, HI (US); Mike Sack, Kailua-Kona, HI (US)

(21) Appl. No.: 13/967,293

(22) Filed: Aug. 14, 2013

Related U.S. Application Data
(60) Provisional application No. 61/692,601, filed on Aug. 23, 2012.

(51) Int. Cl. G06Q 10/00; G06Q 50/00

(52) U.S. Cl. CPC G06Q 10/00; G06Q 50/01
USPC 705/319

(57) ABSTRACT

A method of electronically delivering a story via self-renewing subscription in serial format to a reader. The reader subscribes to the story on the web through an application on her portable device, the reader chooses the form in which she would like to receive inter-narrative and super-narrative messages and provides the information for delivery of such messages, serial story segments are sent out via a content delivery system to the reader in regular intervals, with the delivery system tracking the time of delivery, and inter-narrative and super-narrative messages are sent to the reader.

This application claims priority to U.S. Provisional Patent Application 61/692,601 filed Aug. 23, 2012.

### TECHNICAL FIELD

The invention relates to authoring and publishing systems; more particularly it relates to electronically delivering stories via self-renewing subscription in serial format to a reading public.

### BACKGROUND

Not since Gutenberg invented the printing press has there been as great a paradigm shift in delivering the written word to readers as is going on today. Over the past six years we have seen a revolution in publishing Old, established paper-based publishers are losing customers; bookstores large and small are closing all over the world. At the same time, the use of electronic devices for the consumption of books, magazines and newspapers is growing exponentially, capturing ever more of the reading market every month. Not only has the technology changed, so too has the customer changed. More and more readers are expanding beyond the use of computers to include Kindles, Nooks, iPhones, iPads, and Tablets as well. All these electronic devices allow us to read on the go, but because we are busier than ever before we all read in short spurts rather than in the long sessions of only a few years ago. Our entertainment goes with us now. We can watch television or movies; listen to Podcasts or Pandora Radio and read stories wherever we are. We are also constantly in contact with our “friends” via our electronic social media. We email, Facebook, tweet, text, SMS, etc. We create and join online communities as well as play games with friends and strangers via the “Cloud”.

### DISCLOSURE

What is disclosed is a system that delivers stories via self-renewing subscription in serial format utilizing every available platform (web, iPhone, iPad, Android, etc.) to maximize the impact of the story and immerse the subscriber in its world. Story segments (“chaplets”) are delivered on a regular basis, each chaplet being enhanced by embedded technologies, e.g. video, audio, animation and graphics.

The story being delivered is also enriched by inter-narrative material, such as messages, tweets, Facebook messages and other electronic forms of communication that are sent to the reader from characters in the story. Further enrichment is provided by super-narrative material, such as diary pages, psychological evaluations, medical records, school and police records, etc.

The reading experience is further enhanced with a sense of belonging to the community of the story, of immersion in the story itself. Readers interact with other readers by sharing their thoughts about the storyline and characters, and even their own creations relating to the storyline.

### BRIEF DESCRIPTION OF THE DRAWINGS

There are no drawings.

### BEST MODE

The reader subscribes to the story on the web or through an application on their portable device. At the time of subscription a reader chooses the form in which she would like to receive inter-narrative and super-narrative material (choosing from among email, text, voice, social media messaging and the like) and provides the information to allow the disclosed system to send such messages.

The segments of the story are then sent out via a content delivery system to the reader in regular intervals, with the delivery system tracking not only the time of delivery, but the time the chaplet was read, and even the location of the reader at the time the chaplet is open (if available). Thus, if the chaplet is being read while someone is at Starbucks, servers will note that and optionally instantly send a message from an appropriate character wishing he could stop by for a cup of coffee or a doughnut or the like, something specific to the venue in which the chaplet is being read. After the servers have determined that a specific chaplet has been read by tracking the turns of pages, or such like metric, a series of messages are sent to the reader from one or more of the characters in the story. Each message is programmed to be delivered at specific times during the day in the reader's own time zone so whatever the character is reporting is time-appropriate for every reader. The messages are sent in advance of the arrival of the next segment of the story.

The tracking servers also offer super-narrative material in support of the main storyline at specific times during the story. Thus, if a character has just emerged from a hospital, a reader is optionally offered a look at that character's hospital records, which are relevant to the main story line, though not necessarily crucial. Other examples of super-narrative material beyond those mentioned here and earlier in these pages are such things as teachers report cards of characters, student essays, newspaper accounts of events, obituaries, and the like.

While the entire storyline is written by the author(s), readers can participate by contributing to ancillary media outside the storyline. Thus, there are electronic outlets designed for readers to express themselves via text, audio, video and images that can be shared with other readers. Readers also communicate directly with the authors about the storyline and participate in responding to polls about the storyline. The author(s) design future segments with specific elements that are already known to be attractive to readers.

The author(s) also create additional on-going story lines that originate in one storyline but become separate stories in the system, in their own right, though such stories might intersect with the original at various times as both stories continue.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A method of electronically delivering a story via self-renewing subscription in serial format to a reader, the method comprising the steps of:
the reader subscribes to the story on the web through an application on her portable device;
the reader chooses the form in which she would like to receive inter-narrative and super-narrative messages and provides the information for delivery of such messages;
serial story segments are sent out via a content delivery system to the reader in regular intervals, with the delivery system tracking the time of delivery;
inter-narrative and super-narrative messages are sent to the reader.
